(19) United States
(12) Patent Application Publication
(10) Pub. No.: US 2026/0261182 A1
(43) Pub. Date: Sep. 3, 2026

(54) MECHANICAL RENEWABLE GREEN ENERGY PRODUCTION

(71) Applicant: PHOS GLOBAL ENERGY SOLUTIONS, INC., Fort Lauderdale, FL (US)

(72) Inventors: Victor Bica, Saint James, NY (US); Eugene Earle Rudolph, Port Jefferson Station, NY (US)

(73) Assignee: PHOS GLOBAL ENERGY SOLUTIONS, INC., Fort Lauderdale, FL (US)

(21) Appl. No.: 18/993,310

(22) PCT Filed: Jul. 11, 2023
(86) PCT No.: PCT/US2023/027355

§ 371 Date: Jan. 10, 2025

Related U.S. Application Data
(60) Provisional application No. 63/388,220, filed on Jul. 11, 2022.
(60) Provisional application No. 63/388,223, filed on Jul. 11, 2022.
(60) Provisional application No. 63/388,226, filed on Jul. 11, 2022.
(60) Provisional application No. 63/388,228, filed on Jul. 11, 2022.

(51) Int. Cl. H02K 7/02; F03G 3/08; H02K 7/09; H02K 49/10

(52) U.S. Cl. CPC H02K 7/025; F03G 3/08; H02K 7/09; H02K 49/102

(57) ABSTRACT

An energy storage and production system including at least one flywheel, the flywheel rotating and storing energy therein, at least one motor configured to rotate the flywheel, a magnetic gear box coupling the at least one motor and the at least one flywheel, and a generator magnetically coupled to the magnetic gear box and configured to output energy stored in the flywheel.

### CROSS-REFERENCE TO RELATED APPLICATIONS

The instant application is a National Phase application of PCT/US2023/027355, filed Jul. 11, 2023, which claims priority to U.S. Provisional Application No. 63/388,220 filed Jul. 11, 2022, bearing the title MECHANICAL RENEWABLE GREEN ENERGY PRODUCTION; U.S. Provisional Application No. 63/388,223 filed Jul. 11, 2022, entitled PIPE CONSTRUCTED HOUSING FOR FLYWHEEL; U.S. Provisional Application No. 63/388,226 filed Jul. 11, 2022, entitled MAGNETIC PLANETARY GEARING FOR CIRCLE OF FLYWHEEL SYSTEM; U.S. Provisional Application No. 63/388,228 filed Jul. 11, 2022, entitled RESIDENTIAL FLYWHEEL SYSTEM. Further, this application is related to Patent Cooperation Treaty Application No. WO 2021/096470 filed Aug. 14, 2020, and PCT/US2022/029255 filed May 13, 2022, the entire contents of which are incorporated herein as if set forth fully particularly the descriptions of flywheels and their various uses for storage and allocation of energy on demand.

### TECHNICAL FIELD

This disclosure relates generally to renewable energy devices, and in particular to mechanical renewable energy generation and storage devices.

### BACKGROUND

Renewable energy has become an increasingly important source of electrical energy generation in many countries around the world. As the demand for electrical energy has increased, the impact of fossil fuels on the environment has become magnified and increasingly apparent. In an effort to overcome these obstacles, advancements in green energy generation have continued to accelerate, resulting in innovations such as hydrodynamic generators, wind turbines, geothermal energy, biomass energy, amongst others. However, mechanical energy storage and generation, despite its simplicity, has historically remained rather undeveloped. In traditional mechanical systems, as a load is placed upon the system, the mechanical device driving electrical generators loses momentum, resulting in a drop in electrical energy generation. To avoid this decrease in electrical energy generation, it is necessary to input additional energy to maintain consistency and therefore provide consistent electrical energy generation. As can be appreciated, the constant increase or decrease in energy required to maintain constant electrical energy generation using traditional mechanical systems is inefficient and wasteful.

### SUMMARY

One aspect of the disclosure is directed to an energy storage and production system. The energy storage and production system includes at least one flywheel, the flywheel rotating and storing energy therein; at least one motor configured to rotate the flywheel. The energy storage and production system also includes a magnetic gear box coupling the at least one motor and the at least one flywheel; and a generator magnetically coupled to the magnetic gear box and configured to output energy stored in the flywheel.

Implementations of this aspect of the disclosure may include one or more of the following features. The energy storage and production system where the flywheel includes a magnetic lift bearing and a magnetic levitation bearing. The magnetic lift bearing is formed of two halves. Each of the two halves of the magnetic lift bearing includes a plurality of magnets formed into concentric rings. Each concentric ring of magnets on each of the two halves of the magnetic lift bearing alternates polarity. Each concentric ring of magnets on a first half of the two halves of the magnetic lift bearing is oriented with a polarity opposite that of a corresponding concentric ring of magnets on a second half of the two halves of the magnetic lift bearing, where the opposite polarities cause the first half and the second half of the magnetic lift bearing to attract each other. One or more of the concentric rings of magnets is radially supported by a spacer. The spacer is formed of a glass reinforced plastic material. The energy storage and production system further including one or more shims securing the magnets in the magnetic lift bearing. The energy storage and production system further including a cover securing the plurality of magnets in each half of the magnetic lift bearing. The flywheel includes a magnetic levitating bearing. The magnetic levitating bearing is formed of two halves. A bottom half of the magnetic levitating bearing is machined into a bottom plate of a flywheel enclosure. Each of the two halves of the magnetic levitating bearing includes a plurality of magnets formed into concentric rings. Each concentric ring of magnets in each of the two halves of the magnetic levitating bearing alternates polarity. Each concentric ring of magnets on a first half of the two halves of the magnetic levitating bearing is oriented with an identical polarity of a corresponding concentric ring of magnets on a second half of the two halves of the magnetic levitating bearing, where the identical polarities cause the first half and the second half of the magnetic levitating bearing to repel each other. One or more of the concentric rings of magnets in the magnetic levitating bearing is radially supported by a spacer. The spacer is formed of a glass reinforced plastic material. The energy storage and production system further including one or more shims securing the magnets in the magnetic levitating bearing.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiments given below, serve to explain the principles of the disclosure, wherein:

FIG. 1 is a perspective view of a renewable energy generation system provided in accordance with the present disclosure;

FIG. 2 is a partial, cross-sectional view, of a flywheel assembly of the renewable energy generation system of FIG. 1;

FIG. 3 is a cross-sectional view of half of a magnetic lift bearing in accordance with the disclosure;

FIG. 4 is a perspective view of a magnetic levitating bearing in accordance with the disclosure;

FIG. 5 is a perspective view of a half a magnetic levitating bearing in accordance with the disclosure;

FIG. 6 is a perspective, cross-sectional view, of the half a magnetic levitating bearing of FIG. 5;

FIG. 7 is a perspective, cross-sectional view, of the half a magnetic levitating bearing of FIG. 5, with cover;

FIG. 8 is a perspective view of a base plate of a magnetic levitating bearing of FIG. 5 in accordance with the disclosure;

FIGS. 9A and 9B are cross-sectional views of the magnetic levitation system in accordance with the disclosure;

FIG. 10 is cross-sectional view of a magnetic levitation system in accordance with the disclosure;

FIGS. 11A-11C are cross sectional views of a magnetic levitating system in accordance with the disclosure;

FIG. 12 is a cross-sectional view of magnetic gear in accordance with the disclosure;

FIGS. 13A-13D are cross sectional views of a cooled magnetic gear train in accordance with the disclosure;

FIG. 14 is a perspective view of a magnetic braking system in accordance with the disclosure;

FIG. 15 depicts a top perspective view of a flywheel housing in accordance with the disclosure;

FIG. 16 depicts a top perspective view of a flywheel housing with a top plate in accordance with the disclosure;

FIG. 17 is a cross-sectional view of the top portion of a flywheel in accordance with the disclosure;

FIG. 18 is a cross-sectional view of the bottom portion of a flywheel in accordance with the disclosure;

FIG. 19 depicts a vacuum connector for the flywheel housing of FIG. 16;

FIG. 20 is a perspective view of a flywheel in accordance with the disclosure;

FIG. 21 is a perspective view of a flywheel assembly in accordance with the disclosure;

FIG. 22 is a cross-sectional view of the flywheel assembly of FIG. 21 in accordance with the disclosure;

FIG. 23 is a cross-sectional view of a flywheel assembly in accordance with the disclosure;

FIG. 24 is a top perspective view of the flywheel assembly of FIG. 23; and

FIG. 25 is a top perspective view of the flywheel assembly of FIG. 23, with a cover and a ring gear removed to expose the pinion gears.

### DETAILED DESCRIPTION

Embodiments of the disclosure are now described in detail with reference to the drawings in which like reference numerals designate identical or corresponding elements in each of the several views. In the drawings and in the description that follows, terms such as front, rear, upper, lower, top, bottom, and similar directional terms are used simply for convenience of description and are not intended to limit the disclosure. In the following description, well-known functions or constructions are not described in detail to avoid obscuring the present disclosure in unnecessary detail.

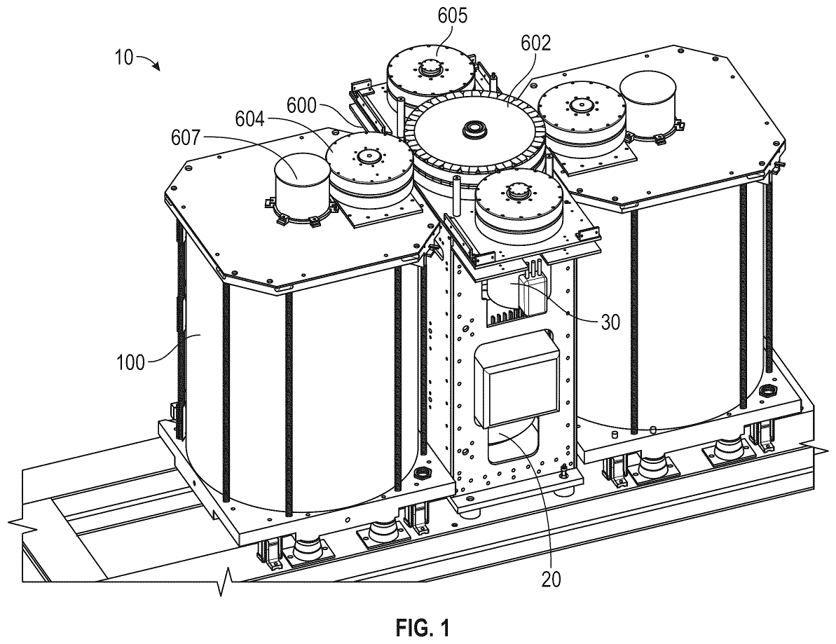

Referring now to the drawings, a renewable energy generation system is illustrated in FIGS. 1-5 and generally identified by reference numeral 10. The renewable energy generation system 10 includes one or more flywheel assemblies 100, one or more motors 20, and one or more generators 30. Each of the one or more flywheel assemblies 100 is substantially similar to one another and therefore, only one flywheel assembly 100 will be described in detail herein in the interest of brevity.

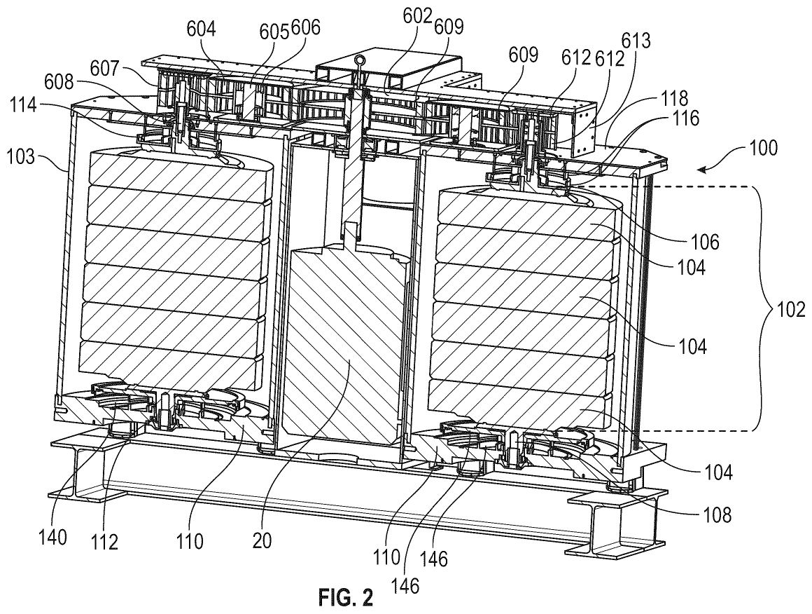

The flywheel assembly 100 includes a flywheel 102 and a flywheel enclosure 103. The flywheel 102 includes one or more flywheel segments 104 disposed substantially coaxially upon one another forming a generally cylindrical profile, although it is contemplated that the flywheel 102 may define any suitable shape, such as a hexagonal prism, a pentagonal prism, octagonal prism, a cube, a rectangular prism, amongst others. In this manner, each flywheel segment 104 defines a generally cylindrical profile having an outer sidewall extending between opposed upper and lower surfaces. Alternatively, it is contemplated that the flywheel 102 may be formed from a single, monolithic piece of material (e.g., billet, casting, etc.). In FIG. 2 the segments are welded together, ground to a generally uniform diameter and then balanced. On the top end of each flywheel 102 a top spindle segment 106 is formed and on a bottom end of each flywheel a bottom spindle segment 108 is formed, the top and bottom spindle segments 106 and 108 enable mechanical coupling of magnetic bearing housings (described below) and in the case of the top spindle segment 106 receive a shaft which rotates a pinion gear of a magnetic gear train (also described below).

As shown in FIG. 2 the flywheel 102 includes multiple flywheel segments 104, each flywheel segments 104 is disposed in a stacked configuration such that a lower surface of a first flywheel segment 104 abuts or otherwise contacts an upper surface of an adjacent flywheel segment 104. Each flywheel segment 104 is coupled to one another using any suitable means, such as welding, adhesives, fasteners, amongst others. Where welding is employed, each flywheel segment 104 is coupled to one another by laser welding, electron beam welding, etc.

Continuing with FIG. 2, the flywheel 102 is disposed within a flywheel enclosure 103. The flywheel enclosure 103 may be formed of a steel pipe or other suitable material capable of maintaining a deep vacuum (e.g., approaching 0 psi, mm Hg, etc.) when appropriately sealed. The flywheel enclosure 103 mates with a base plate 110 and one or more rubber sealing rings (not shown) may be employed to ensure a substantially air-tight fit between the flywheel enclosure 103 and the base plate 110. A bore 112 in the base plate 110 is configured to receive a portion of the bottom spindle segment 108 and a bearing (e.g., a roller bearing) may be optionally employed in the bore to receive the portion of the bottom spindle segment 108 and take up any lateral forces.

It is envisioned that the base plate 110 may be formed from any suitable material, such as aluminum, steel, stainless steel, tungsten, alloys, composites, polymers, and combinations thereof. In embodiments, the base plate 130 may be formed from the same or different material than that of the flywheel enclosure 103 or flywheel 102. It is contemplated that the base plate 110 may be coupled to the flywheel enclosure 103 using any suitable means, such as fasteners, adhesives, welding, amongst others, and may include a gasket (not shown) or other suitable device capable of forming a vacuum tight seal interposed between the base plate 110 and the flywheel enclosure 103.

Mounted on the top spindle 106 of each flywheel 102 is a magnetic lift bearing 114. As will be explained the magnetic lift bearing 114 is formed of two halves 116. A lower half 116 is secured to the top spindle 106, and an upper half 116 may be secured to a top plate 118. of the flywheel 102. The top plate 118 along with bottom plate 110 complete the flywheel enclosure 103 and form a vacuum tight space in which the flywheel 102 rotates substantially free of friction.

The magnetic lift bearing 114 has a generally circular profile, and may be formed from any suitable material, such as aluminum, steel, stainless steel, tungsten, alloys or combinations thereof. Alternatively, the magnetic lift bearing 14 may be formed entirely from a permanent magnet, such as a ceramic or ferrite magnet, a neodymium magnet, an alnico magnet, an injected molded magnet, a rare earth magnet, a magnetic metallic element, amongst others, although it is contemplated that the magnet may be an electromagnet.

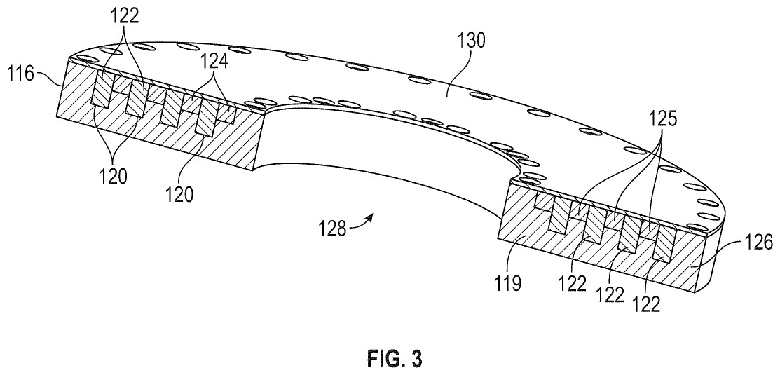

A cross-sectional view of the bottom half 116 of the magnetic lift bearing 114 is depicted in FIG. 3. The bottom half 116 of the magnetic lift bearing includes base 119 having formed thereon a plurality of channels 120. In the channels 120 are placed magnets 122. The magnets 122 are arranged to form a ring of magnets. In one aspect of the disclosure the rings of magnets 122 are separated by spacer rings 124. The spacer rings 124 assist with alignment of the individual magnets 122 and also absorb stresses caused by rotation of the bottom half 116 of the magnetic lift bearing 114. As will be appreciated, the flywheels 102 rotate at between 4000 and 15,000 RPM. At those velocities, the mass of the magnets 122 creates significant sheer stresses on the magnets 122. The spacers 124 mitigate those stresses and prevent the magnets 122 from moving with the bottom half 116 of the magnetic lifting bearing 114. An outer ring 126 of the base 119 may have a thickness greater than either the magnets 122 or the spacers 124, again to absorb and withstand the stresses caused by the velocities at which the flywheel 102 is spinning, and particularly the stresses caused by the rotational speeds of the magnets 122. A through-bore 128 allows the bottom half 116 to receive the top spindle 106 therethrough. A top plate 130, formed of a non-magnetic material is secured to the base 119 (e.g., via fasteners) to ensure the magnets 122 and spacers cannot move vertically. The top plate 130 may be formed from any suitable non-magnetic material, such as a metallic material (e.g., aluminum, stainless steel, etc.), a polymer, a composite, amongst others. In one non-limiting embodiment, the cover plate is formed from a carbon composite material.

Though described herein as employing spacers 124, the spacers 124 may be replaced by rings of magnets 125 having a smaller vertical dimension than the magnets 122. The rings of magnets 125 and the rings of magnets 122 can be oriented such that each ring of magnets 125 has the opposite polarity facing towards the top plate 130 then the neighboring rows of magnets 122. Still further, though generally described herein as being formed of a plurality of generally square or rectangular cubes of magnetic material, the magnets 122 and 125 may instead be formed of a machined rings of magnetic material configured to be received in the channels 120 or between another ring of magnets 122 or 125 as concentric rings of magnets 122 or 125.

Though described herein as two separate components the top spindle 106 may be machined to form the bottom half 116 of the magnetic lift bearing 114 and receive the magnets 122 and spacers 124. Such operation reduces the number of parts, eliminates the fastening of the bottom half 116 to the top spindle 106 as a potential failure point, and reduces machining costs associated with the fit of the top spindle 106 to receive the bottom half 116 of the magnetic lift bearing 114.

The top half 116 has substantially the same construction as the bottom half 116. Those of ordinary skill in the art will recognize that the top half is stationary and thus does not experience the stresses associated with the high rotational speeds of the flywheel 102. The spacers 124 of the bottom half 116 may require a material with increased compression resistance such as carbon fiber materials, while the spacers 124 of the upper half 116 may be formed of a less resistant material such as a fiberglass material.

As with the bottom half 116, the top half 116 may be formed of a separate base 119 that is secured to the top plate 118 of the flywheel 102. The top half 116 may then be secured to the top plate 118 via one or more fasteners. Alternatively, the top plate 118 may be machined with the grooves 120 to receive the magnets 122 and spacers 124 therebetween.

The magnets 122 in the bottom half 116 may be arranged such that each groove 120 receives magnets with their polarity arranged opposite that of the magnets 122 in its neighboring channels. Thus, with reference to FIG. 3, the inner most channel 120 may have all magnets 122 arranged such that a north pole is facing upward, the next channel 120 will then have all south poles facing upward, the third channel 120 will again have all north poles of the magnets 122 facing upwards, while the fourth and outermost channel 120 will again have all south poles facing upward.

Because one goal of the magnetic lift bearing 114 is to lift the flywheel 102 vertically, the arrangement of the polarities of magnets 122 in the top half 116 will be opposite that of the bottom half. In this way the polarities of the magnets 122 in the top half 116 will attract the magnets 122 in the bottom half 116 to lift flywheel 102. This lifting of the flywheel 102 reduces the load on a bearing in the bore 112 of the base plate 110.

In addition, by alternating the orientation of the polarities of the magnets 122 from one channel 120 to the next channel, a magnetic radial bearing is formed. The alternating polarities of the magnets 122 in the top half 116 (e.g., N-S-N) are opposite alternating polarities of magnets 122 in the bottom half (e.g., S-N-S). While the opposite polarities cause the magnets 122, and therewith the two halves 116 to be attracted towards one another (i.e., creating lift, as described above), they also prevent the top half 116 from moving laterally or transversely with respect to the bottom half 116. The alternating pattern of the rings of magnets 122 of the top half 116 is offset from the alternating pattern of the polarity of the rings of magnets 122 of the bottom half 116. As a result, where there are for example two rings of magnets 122 with their south pole facing the top plate 130 of the top half 116, in the bottom half 116 there will be a ring of magnets 122 with its south pole facing the top plate 130 and be positioned laterally or transversely between the two rings of magnets 122 of the top half 116. The magnetic repulsion of the offset south poles of the rings of magnets 122 of the top half 116 act against the south pole of the rings of magnets 122 in the bottom half, and magnetically act to keep the magnet 122 of the bottom half 116 aligned laterally or transversely between the two rings of magnets 122 of the top half. As will be appreciated, the top half 116 and the bottom half 116 may each have up to 20 rings of magnets 122, and these offset opposing magnetic forces prevent the top half 116 from moving laterally or transversely with respect to the bottom half 116 once the respective magnets 122 are aligned as set forth above to form the radial bearing allowing frictionless rotation of the flywheel 102 while maintaining the vertical alignment of the flywheel 102. In contrast, traditional mechanical radial bearings (e.g., roller bearings or ball bearings) suffer from friction, generate heat, and require maintenance. Thus, this arrangement acts as a radial bearing that help ensure vertical alignment of the flywheel 102 and reduce any lateral lodes on both the mechanical bearing in the base plate 110 and the mechanical bearing in the top plate 118 through which a portion of the top spindle 106 passes to connect with the gearing (described below) outside of the flywheel enclosure 103. As will be appreciated, in some aspects of the disclosure, no mechanical bearings are used in the top plate 118 or bottom plate 110 owing to the radial bearing effect generated by these alternating polarity rows of magnets 122 in each channel 120.

The magnets 122 of the magnetic lift bearing 114 may each have substantially uniform dimensions (e.g., 1″ length×1″ width×1.25″ depth). Owing to the changes in radial dimensions of the channels 120 from the inner most to the outermost channel 120, more magnets 122 may be deployed in the outer channels 120 as compared to the inner channels 120. Similarly, the magnets 125 may also have similar dimensions, albeit with a shallower depth than the magnets 122 (e.g., 1″ depth). In addition, rather than individual, generally cuboid magnets 122 or 125, the magnets may be machined as rings, as described above.

Shims (not shown) may be utilized between adjacent individual magnets 122 to reduce the potential for movement of the magnets 122 and accommodate any expansion of the magnets 122 as they heat due to eddy currents induced by the rotation of the magnets 122 of the bottom half 116 relative to the top half 116. Those of ordinary skill in the art will recognize that the dimensions provided above are merely demonstrative, and a variety of dimensions of the magnets may be used without departing from the scope of the disclosure. In addition, it is envisioned that each magnet 122 may be formed from the same or different materials, or combinations thereof, and in embodiments, may be formed from a permanent magnet, such as a ceramic or ferrite magnet, a neodymium magnet, an alnico magnet, an injected molded magnet, a rare earth magnet, a magnetic metallic element, amongst others.

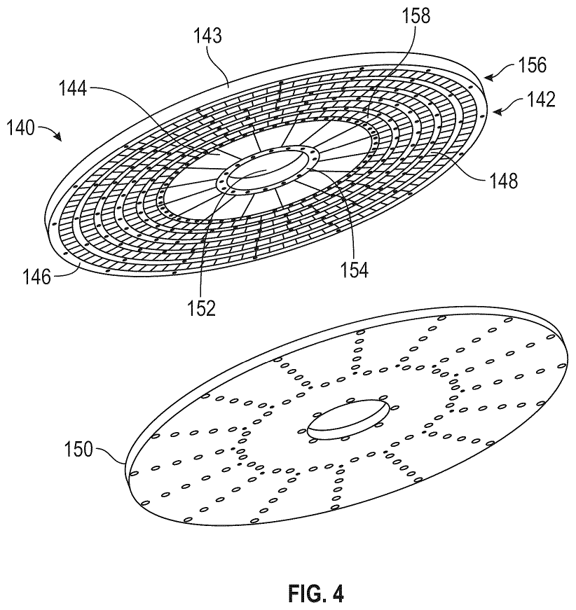

FIG. 4 depicts a top half 142 of a magnetic levitation bearing 140 in accordance with the disclosure. As with the magnetic lifting bearing 114, above, the magnetic levitation bearing includes a base plate 143, a plurality of first magnets 144, a plurality of second magnets 146, a plurality of spacers 148, and a cover 150. The base plate 143 defines a bore 152 extending there through. The bore 152 is configured to be received on and secured to the bottom spindle 108. The bore 152 defines an inner diameter of an inner ring 154 machined into the base plate 142. An outer ring 156 is also machined into the base plate 143. The base plate 143 defines a generally planar configuration and may be formed from any suitable material, such as a metallic material, a non-metallic material, a composite, a ceramic, amongst others. In one non-limiting embodiment, the base plate 143 is formed from steel. As an alternative, one or more of the spacers 148 may alternatively be an annular ring machined into and from the same material of the base plate 143.

Each of the spacers 148 include a generally circular profile and may be formed from any suitable material, such as a metallic material, a non-metallic material, a composite, a ceramic, amongst others. In one non-limiting embodiment, the spacers 148 are formed from a fiber-reinforced plastic, which may be a glass-reinforced plastic, carbon-reinforced plastic, aramid reinforced plastic, amongst others.

In accordance with one aspect of the disclosure the first magnets 144 has a truncated pie shape such that the first magnets 144 extend from the inner ring 154 of the base plate 143 to a first spacer 148. A second ring 158 may be optionally machined into the base plate 143 and configured to retain the first magnets 144 between the inner ring 154 and the second ring 158. Those of ordinary skill in the art will recognize that other shapes of the first magnets 144 may be employed without departing from the scope of the disclosure. The second magnets 146, in accordance with this aspect of the disclosure are generally square or rectangular in shape. As with the magnetic lift bearing 114, grooves 120 may also be formed in the base plate 143 to receive the second magnets 146. The magnets 144, 146 may be formed from a permanent magnet, such as a ceramic or ferrite magnet, a neodymium magnet, an alnico magnet, an injected molded magnet, a rare earth magnet, a magnetic metallic element, amongst others.

As depicted in FIG. 4, the second magnets 146 are arranged in a plurality of rings separated by a spacer 148. It is contemplated that each ring of the second magnets 146 may utilize magnets of the same or of different dimensions, depending upon the design needs of the magnetic levitation disk 140. As will be appreciated, outer rings of the second magnets 146 may require additional magnets as compared to more inner rings. Further, one or more shims may be employed between each of the second magnets 146 in each of the plurality of rings, as needed to prevent movement of the magnets relative to each other. Each of the first magnets 144 or the second magnets 146 and any spacer 148 or and shim employed may be secured to the base plate 143 using suitable means, such as fasteners, adhesives, epoxy, etc.

As with the magnetic lifting bearing 114, the magnets may have alternating orientations. For example, first magnets 144 may all be arranged such that the same pole (e.g., the north pole) is facing away from the base plate 143. An inner most ring of the second magnets 146 may then be arranged with the south poles facing away from the base plate 143. Each successive ring of second magnets 146, then has an alternating arrangement.

A bottom half of the magnetic levitating bearing 140 is substantially identical to the top half 142. However, unlike the magnetic lifting bearing 114, where the goal is to attract the two halves 116 together, and thus opposing polarities of the magnets of the bottom half 116 and the top half 116 are aligned, a bottom half 142 of magnetic levitating bearing 140 has an identical arrangement of the first magnets 144 and the second magnets 146. In this way, the top half 142, which may be mounted to the bottom spindle 108, and particularly the first magnets 144 and the second magnets 146 have polarities aligned with directly opposing the first magnets 144 and second magnets 146 in the bottom half. Specifically, if as noted above the first magnets 144 of the top half 142 have a north pole facing away from the base plate 143, so to the first magnets 144 of the bottom half will have first magnets with the north pole facing away from the base plate 143. These opposing magnetic poles will force the flywheel 102 away from the base plate 110, lifting the flywheel in the direction of the top plate 118. Further, as with the magnetic lifting bearing 114, the alternating polarity of the rings of the second magnets 146 creates a radial bearing effect, maintaining the vertical orientation of the flywheel 102 and limiting any radial loads on the mechanical bearings that are optionally configured to receive portions of the top spindle 106 or the bottom spindle 108. Thus, in accordance with one aspect of the disclosure, the flywheel 102 in the flywheel housing 103 is held weightless relative to any mechanical bearing in the top spindle 106 or the bottom spindle 108, resulting in a near limitless lifespan of any such mechanical bearing.

As noted above the second magnets 146 may be square or rectangular resulting in a cube or rectangular cube shape, although it is contemplated that each of the second magnet include any suitable profile and may include the same or different profile from one another. Although generally described as having the same dimensions it is envisioned that each ring of second magnets 146 may be different than the others.

The cover 150 may be secured to the top half 142 of the magnetic levitation bearing 140 via one or more fasteners. A similar cover 150 may be incorporated into a bottom half of the magnetic levitating bearing 140 may be machined as part of the base plate 110. Machining the bottom half of the magnetic levigating bearing 140 may reduce the number of parts necessary for the flywheel assembly 100, and therewith the costs. Similarly, the top half of the magnetic levitating bearing 140 may be machined into the bottom spindle 108. As noted above, machining the top half 142 and the bottom half of the magnetic levitating bearing into the bottom spindle 108 and the base plate 110 reduces the machining the required to ensure that a portion of the bottom spindle 108 passes through the bore 112 in the base plate 110 to made with a mechanical bearing, if employed.

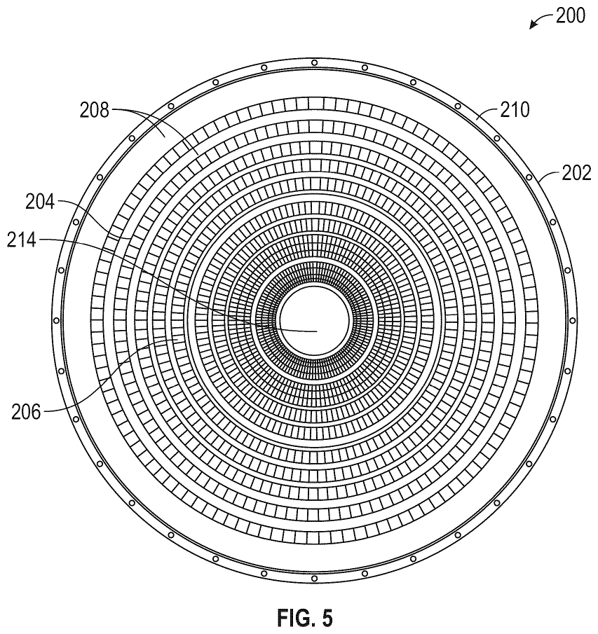

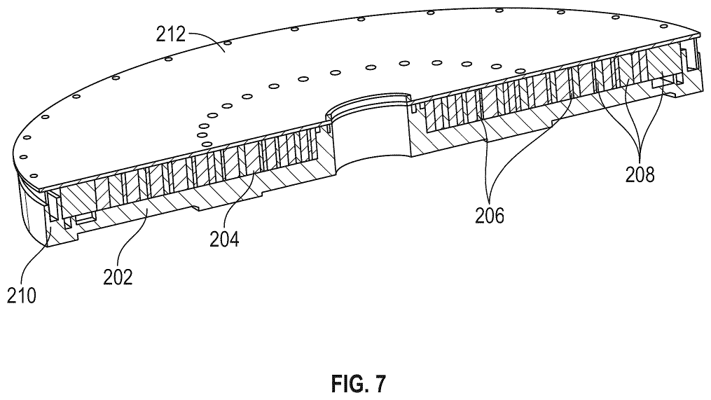

Turning to FIGS. 5-8, another embodiment of a magnetic levitation bearing is illustrated and generally identified by reference numeral 200. The magnetic levitation bearing 200 includes a base plate 202, a plurality of magnetic magnets 204, a plurality of retention rings 206, a plurality of spacers 208, an outer base plate ring 210, and a cover plate 212.

The base plate 202 has a generally circular configuration having an outer surface. A bore 214 is defined in the base plate 202 for mounting on a bottom spindle 108. The base plate 202 defines a generally planar configuration and may be formed from any suitable material, such as a metallic material, a non-metallic material, a composite material, a ceramic, amongst others. In one non-limiting embodiment, the base plate 202 is formed from a steel material.

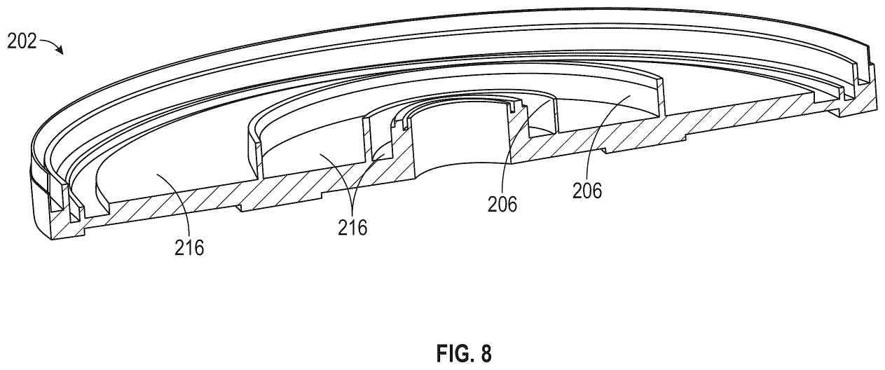

The base plate 202 includes a plurality of annular grooves, 216 (See FIG. 8). Each of the annular grooves 216 disposed concentric to one another extending in a direction radially outward from the bore 214. Each annular groove 216 is defined by the retention rings 206. The radial length (e.g., the gap formed between each annular boss) of each of the annular grooves 216 increases in a direction radially outward (e.g., from the bore 214 towards the outer base plate ring 210.

Continuing with FIGS. 5-8, the plurality of magnets 204 include magnets of different sizes. Although the plurality of magnets 204 include different dimension from one another, the overall shape of each of the plurality of magnets generally include a dimension that is smaller in the radial direction than a dimension in a direction transverse to the radial direction to reduce stresses (e.g., shear stress) within the plurality of magnets 204 as a result of centripetal forces caused by rotation of the magnetic levitation disk 200. As can be appreciated, the overall dimensions of each of the plurality of magnets generally produce a uniform magnetic field and utilizes the high magnetic fields generates at the edges of each of the plurality of magnets 204 to produce high magnetic forces and inhibit cogging that may be associated with larger magnetic elements.

In accordance with the disclosure the magnets 204 generally have a small dimension in the radial direction when packaged in concentric rings (e.g., ¼^{th} inch, ½ inch, ¾ths inch or 1 inch.” This reduced dimension reduces shear stress in the magnet caused by the large centripetal forces. Additionally, the magnetic fields are generally much higher near the edges of the magnets 204 and considerably lower at the mid regions. The smaller magnet dimension produces a more uniform magnetic field and takes great advantage of the edge feature for higher magnetic forces and less cogging associated with large magnets. Magnets typically have similar mechanical strength isotropy as glass, very high compressive strength, and relatively weak tensile and shear strength. As described herein, a feature to improve magnetic field strength, is to place a gap between the concentric rings of magnets 204 to allow a return path for the lines of magnetic flux for maintaining high magnetic field strength. Similar functionality may be achieved with each concentric ring of magnets 204 alternating polarity.

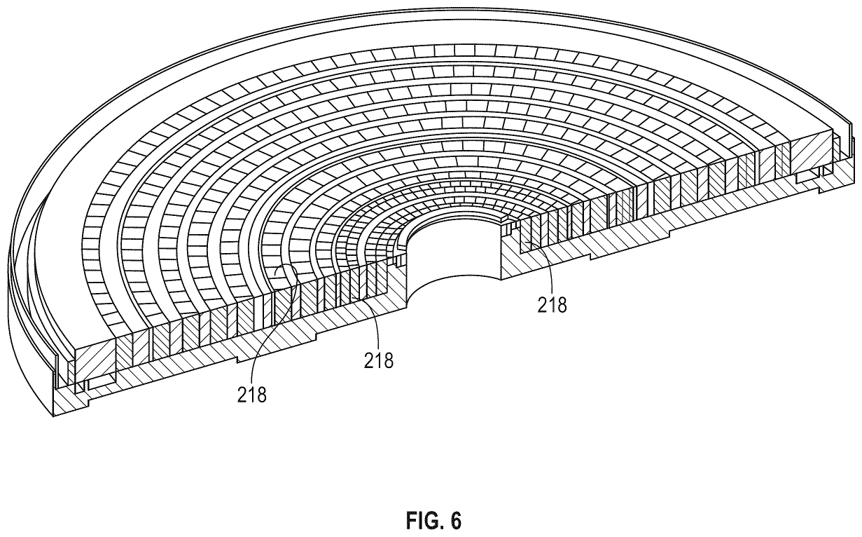

As can be appreciated, manufacturing tolerances for each of the plurality of magnets may result in a gap being formed between each of the three annular rings 206. One or more layers of shims 218 may be interposed between the magnets 204 (FIG. 6) minimize or otherwise eliminate any gap that may be presented therebetween. In accordance with the disclosure the shims 218 may be formed from any suitable material capable of being manufactured in a thickness of about 0.001 inches and may be a resilient material. In one non-limiting embodiment, the one or more layers of shims 1126 are formed from mylar. Although generally described as having a thickness of about 0.001 inches, it is envisioned that the one or more shims may include any suitable thickness and may include the same or different thickness depending upon the design needs of the magnetic levitation bearing 200.

The shims may be formed of Mylar® (a polyester film) with compressive and tensile strengths near that of aluminum. Room temperature creep measurements on Mylar® in compression are extremely low. The Mylar ® is available in small thickness increments 0.0005, 0.001, 0.002, 0.003, 0.004, 0.005, 0.007, 0.010, 0.014 and is needed to remove any radial gaps in the concentric construction to account for waterjet tolerances. Radial assembly tolerances are also a result of carbon hoop tolerances in the radial direction. The magnets interface directly with the glass filled polymer and may apply as much as 5,600 psi to the polymer. The polymer, which is 12 times less stiff than the magnets, will cushion the interface of the magnet's centripetal load path to the carbon hoop. The magnet material can theoretically take 120,000-130,000 psi in pure compression. The 40% glass polymer has a convex shape water-jetted at the interface to the magnet to reduce internal shear stresses in the magnet. The waterjet process may also produce a drafted kerf which may be used to our advantage by positioning it, so the radial forces push the magnet into the base steel rather than away from the steel due to the sine of the kerf angle.

It is envisioned that the plurality of spacers 208 may be formed from any suitable material, and in one non-limiting embodiment, is formed from a carbon reinforced plastic (e.g., carbon composite) material having stiffness modulus that is up to 160%-200% that of the material from which the base plate 202 is formed. In one non-limiting embodiment, the yield strength of the material from which the plurality of spacers 208 is formed is approximately 300,000 psi, although it is contemplated that the yield strength may exceed 300,000 psi. It is envisioned that as the magnetic levitation bearing 200 is rotated, the plurality of spacers 208 expand at nearly the same rate of the material from which the base plate 202 is formed to inhibit radial sliding of the plurality of magnets 204 relative to the base plate 202. In embodiments, the material from which the base plate 202 is formed may be coated with a nickel alloy including Teflon to inhibit sliding friction and wear at the interface between the plurality of magnets 204 and portions of the base plate 202. The plurality of spacers 208 also maintain a gap between each of the annular rings of the plurality of magnets 204 which enables a return path for magnetic flux lines from each of the plurality of magnets 204, which as can be appreciated, maintains a magnetic field strength of the plurality of magnets 204 across the base plate 202. In some aspects of the disclosure, the magnets 204 in each ring of magnets may be disposed in the same orientation (e.g., north facing upward or south facing upward). As will be appreciated, while FIG. 5 depicts a half of a magnetic levitating bearing 200 as may be secured to a bottom spindle 108, a similar second half of the magnetic levitating bearing 200 may be secured to or formed in the base plate 110. Alternatively, and as described elsewhere herein, each ring of magnets 204 may alternate in polarity (e.g., a first ring of the plurality of magnets with north facing upward, a second annular ring of magnets 204 south facing upward and continuing the alternating pattern for all rings of magnets 204. Where pairs of rings of magnets 204 neighbor each other without a spacer 208 therebetween, such as depicted in FIG. 5 nearer the bore 214, those neighboring rings may have the same magnetic orientation or alternating magnetic orientation.

The spacers 208 may include an inner surface (not shown) that is contoured to reduce normal and shear stresses. It is envisioned that the inner surface of the spacers 208 may include a convex profile to reduce internal stresses, such as shear stresses, within the plurality of magnets 204. In embodiments, the spacers 208 may include an upper portion that is wider (e.g., in a radial direction) than width of a lower portion, such that the inner surface is slanted or otherwise disposed at an angle relative to the upper and lower surfaces. In this manner, as the plurality of magnets 204 is caused to expand or otherwise be urged radially outward, the slope of the inner surface causes the plurality of magnets 204 to be urged towards the bottom surface of base plate 202. In embodiments, the spacers 208 may be formed from a glass filled polymer, such as polyetherimide. An example of a polyetherimide material is Ultem® manufactured by Saudi Basic Industries Corporation. The stiffness of the spacers 208 is less than a stiffness of the plurality of magnets 204, such that the spacer acts as a cushion between the plurality of magnets 204.

The cover 212 may be formed from any suitable material, such as a metallic material, a non-metallic material, a ceramic, a composite, etc. In one non-limiting embodiment the cover plate 212 is formed from carbon reinforced plastic (e.g., carbon composite).

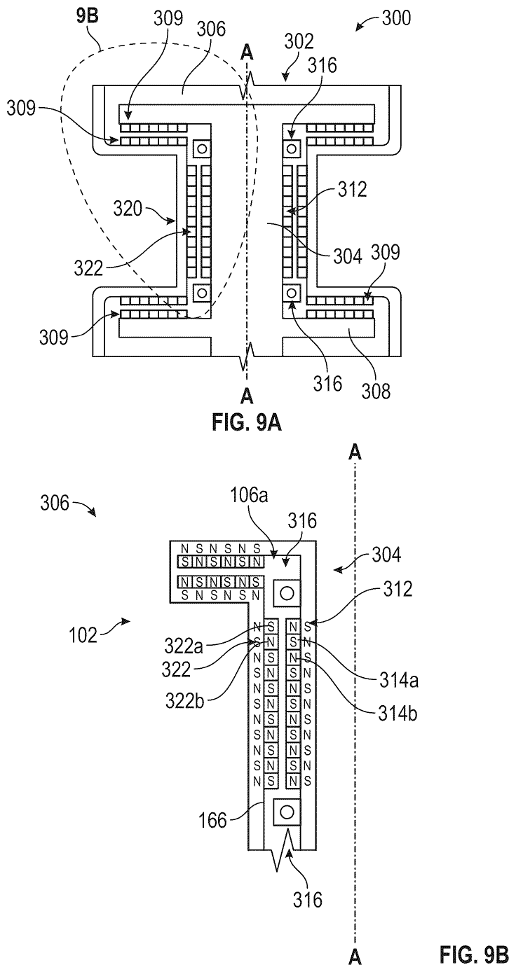

Turning to FIGS. 9A and 9B, a magnetic lift collar is illustrated and generally identified by reference numeral 300. The magnetic lift collar includes a stationary collar 302 and a movable collar 320 that is coupled to an interior portion of the flywheel 102, as will be described in further detail hereinbelow.

The stationary collar 302 defines a generally spool shaped configuration having a center shaft 304 interposed between opposing upper and lower flanges 306 and 308, respectively. As an alternative to the embodiments described herein above, the top spindle 106 and bottom spindle 108 can be configured to mate with or include the movable collar 320 and the stationary collar 302 can be mounted to the top plate 118 or base plate 110. The center shaft 304 includes a generally cylindrical profile and extends the upper flange 306 and the lower flange 308.

A magnetic levitation disk 309 is disposed on the bottom surface of the upper flange 306 and is magnetically coupled to a corresponding magnetic levitation disk 309 disposed on an upper surface of the movable collar 320. As can be appreciated, the magnetic levitation disks 309 disposed on each of the bottom surface of the upper flange 306 and the upper surface of the movable collar 320 interact in a similar manner to the magnetic levitation bearings 140 and 200 described hereinabove.

The lower flange 308 defines a generally circular profile. A magnetic levitation disk 309 is disposed on the top surface of the lower flange 308 and is magnetically coupled to a corresponding magnetic levitation disk 309 disposed on a lower surface of the movable collar 320. Similar to the upper flange, each of the magnetic levitation disks 309 disposed on the top surface of the lower flange 308 and the bottom surface of the movable collar 320 interact in a similar manner to the magnetic levitation bearings 140, 200 described hereinabove.

As can be appreciated, the magnetic levitation disks 309 act in an opposed fashion that urges the stationary collar 302 in a first direction (e.g., up) while the magnetic levitation disk 309 disposed on the lower flange 308 urges the stationary collar 302 in a second direction that is opposite to the first direction (e.g., down) to capture or otherwise inhibit vertical movement of the movable collar 320, and therewith the flywheel 102. In this manner, the flywheel 102 is rotatably supported by the stationary collar 302 such that the flywheel 102 is permitted to rotate about a vertical axis “A” and inhibited from translating or otherwise moving in a transverse direction (e.g., sliding, tilting, wobbling, etc.). It is envisioned that one or both of the upper and lower flanges 306, 308 may be machined integral with the center shaft 304 or may be separate components that are joined to the center shaft 304 using any suitable means, such as fasteners, welding, adhesives, amongst others. In embodiments, one or both of the upper and lower flanges 306, 308 may be a magnetic levitation disk 140 or 200 that is coupled to the center shaft 304 using any suitable means.

Continuing with FIGS. 9A and 9B, the center shaft 304 includes a plurality of magnetic elements 312 disposed thereon about the circumference thereof. The plurality of magnetic elements 312 is disposed about the circumference of the center shaft 304 in a plurality of rows disposed along the vertical axis “A.” The polarity of each row of the plurality of rows alternates along the vertical axis “A” such that a first row 314a includes a north polarity facing outwards and a second row 314b includes a south polarity facing outwards, etc. Similar to the magnetic levitation disks 309 described herein above, the alternating rows of polarity of the plurality of magnetic elements 312 aid in locating the center shaft 304 inhibit vertical movement of the flywheel 102 relative to the center shaft 304.

With reference to FIGS. 9A and 9B, the movable collar 320 includes a plurality of magnetic elements 322 disposed on an inner surface of the movable collar 320 a plurality of rows disposed along the vertical axis “A.” The polarity of each row of the plurality of rows alternates along the vertical axis “A” such that a first row 322a includes a polarity that is opposite to the polarity of the magnetic elements 322 of the first row 314a of the plurality of magnetic elements 312 of the stationary collar 302 and a second row 322b likewise includes a polarity that is opposite to the polarity of the magnetic elements 312 of the second row 314b of the plurality of magnetic elements 312. In this manner, the plurality of magnetic elements 312 attract or otherwise urge the plurality of magnetic elements 322 of the movable collar 320 towards one another. As can be appreciated, as the magnetic elements 322 and 312 are disposed in a circumferential manner, thereby urging a vertical axis of the flywheel 102 to align or otherwise be coaxial with the vertical axis “A” of the stationary collar 302.

In embodiments, the center shaft 304 may include at least one bearing or bushing 316 disposed thereon. The bearing 316 is disposed about the outer surface of the center shaft 304 and is configured to function as a safeguard should the magnetic array fail or otherwise allow the stationary collar 302 to translate or otherwise move off the vertical axis “A.” In the event that plurality of magnetic elements 314 no longer maintains alignment of the flywheel 102 with the vertical axis, an outer portion of the bearing 316 abuts or otherwise contacts a portion of the movable collar 320 inhibit further misalignment of the flywheel 102 and potential damage to the renewable energy generation system 10. In one non-limiting embodiment, the center shaft 304 includes two bearings 316 disposed in spaced apart relation to one another along a length of the center shaft 304 (e.g., along the vertical axis “A”).

Although generally described herein as being a bearing, it is envisioned that the bearing 316 may be a bushing or other similar device capable of permitting rotation of the flywheel 102 and inhibiting lateral movement of the flywheel 102 when the flywheel 102 contacts the bearing 316. In this manner, it is envisioned that the bearing 316 may be a ball bearing (e.g., a radial bearing, a needle bearing, etc.), a plain bearing (e.g., a bronze bushing, a polymer bushing, a journal bearing, a jewel bearing, etc.), a fluid bearing, or any other suitable mechanical load bearing device. Further though described as a stationary collar 302 and a movable collar 320, those designations may be reversed with collar 302 attached to the flywheel 102 and configured to rotate therewith and collar 320 attached to the top plate 118 or the base plate 110 without departing from the scope of the disclosure.

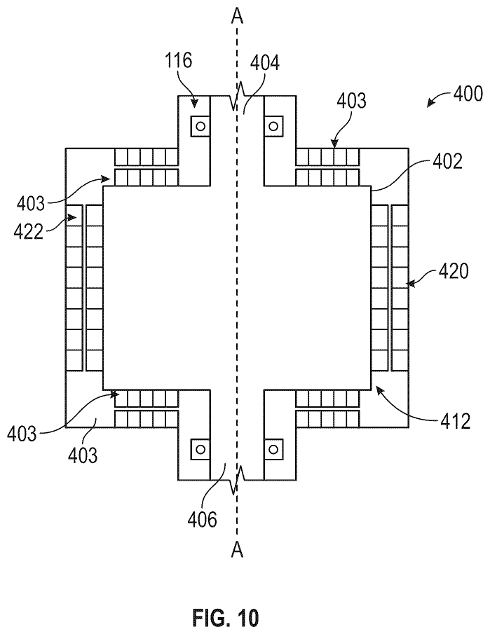

Turning to FIG. 10, another embodiment of a magnetic lift collar is illustrated and generally identified by reference numeral 400. The magnetic lift collar 400 is substantially similar to the magnetic lift collar 300 described herein above and therefore, only the differences therebetween will be described in detail herein in the interest of brevity.

The stationary collar 402 includes a generally cylindrical profile. The stationary collar 402 includes an upper stem 404 and a lower stem 406 extending longitudinally therefrom along the longitudinal axis “A.” The top and bottom surfaces of the stationary collar 402 include a respective magnetic levitation bearing 403 disposed thereon in a similar manner as described hereinabove with respect to the magnetic lift collar 300. The stationary lift collar 402 includes a plurality of magnetic elements 412 that is substantially similar to the plurality of magnetic elements 312. Magnetic elements 422 formed on the movable collar 420 interact with the magnetic elements 412 to maintain vertical alignment of the flywheel 102, as described above. Each of the upper and lower stems 404, 406 include a respective bearing 416 disposed thereon that is substantially similar to the bearing 316 described in detail hereinabove.

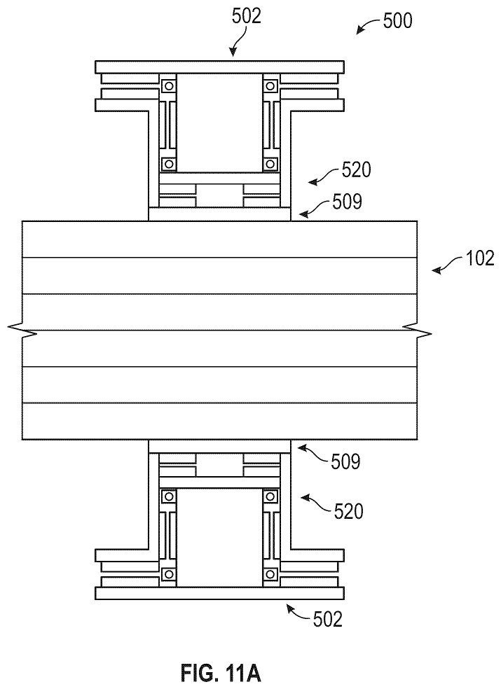

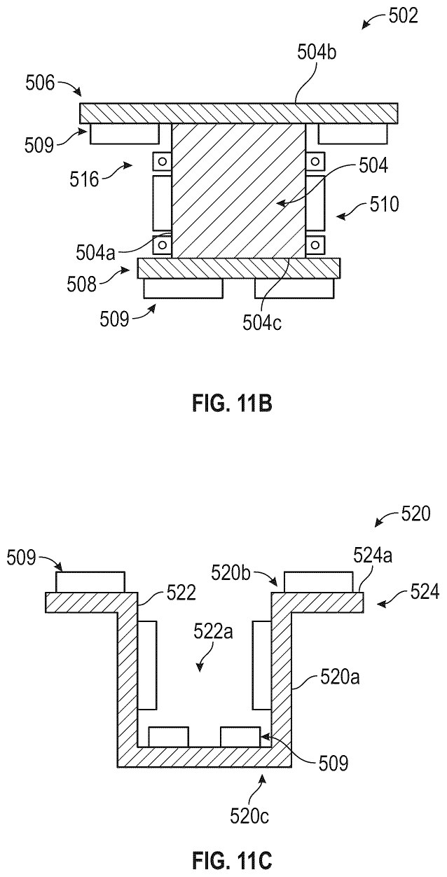

With reference to FIGS. 11A-11C, another embodiment of a magnetic lift collar is illustrated and generally identified by reference numeral 500. The magnetic lift collar 500 includes a stationary collar 502 and a movable collar 520. The stationary collar 502 defines a generally spool shaped configuration having a center shaft 504 interposed between opposing upper and lower flanges 506 and 508, respectively. The center shaft 504 defines a generally cylindrical profile. The outer surface of the center shaft 504 includes a magnetic array 510 disposed thereon about the circumference thereof. The magnetic array 510 is substantially similar to the magnet arrangement of magnets 322 and 314 described herein above. The center shaft 504 includes at least one bearing or bushing 516 disposed thereon in a substantially similar manner to the bearing 316 described herein above.

The upper and lower flanges 506, 508 are substantially similar to the upper and lower flanges 306, 308 described hereinabove. One or both of the upper and lower flanges 506, 508 may be a magnetic levitation bearing 509 that is operably coupled to the center shaft 504 using any suitable means, such as fasteners, adhesives, welding, etc. and may be selectively or permanently affixed to the center shaft 504. In one non-limiting embodiment, the stationary collar 502 is a unitary component formed from the same piece of material via machining or additive manufacturing processes. In embodiments, the lower flange 508 may include an outer dimension that is less than an outer dimension of the upper flange 506, although it is contemplated that the lower flange 508 may include an outer dimension that is greater than the outer dimension of the upper flange 506. In one non-limiting embodiment, the upper flange 506 includes an outer dimension that is three times larger than the outer dimension of the lower flange 508.

Continuing with FIGS. 11A-11C, the movable collar 520 defines a generally “T” shaped configuration and includes an outer surface 520a extending between opposed first and second end portions 520b and 520c, respectively. The movable collar 520 includes an inner surface 522 defining a bore 522a extending through each of the first and second end portions 520b, 520c, respectively. The bore 522a includes an inner dimension that is substantially equal to an outer dimension of a magnetic levitation disk 509.

The outer surface 520a includes an annular flange 524 disposed thereon adjacent the second end portion 520c and extending radially outward from the outer surface 520a. The annular flange 524 defines a planar surface 524a that is substantially co-planar with the second end portion 520c of the movable collar 520. It is contemplated that the annular flange 524 may be integral to the movable collar 520 (e.g., formed from the same component via machining, additive manufacturing, etc.) or may be a separate component that is joined to the movable collar 520 using any suitable means, such as welding, fasteners, adhesives, press fit, amongst others. The planar surface 524a of the annular flange 524 includes a magnetic levitation disk 509 disposed thereon that corresponds to the magnetic levitation disk 509 disposed on the upper flange 506 of the stationary collar 502. Such that the respective magnetic levitation disks 140 urge the stationary collar 502 away from the movable collar 520.

Returning to FIGS. 1 and 2, a magnetic gear train 600 is depicted on the top of the flywheel assembly 100. The magnetic gear train is formed of a drive gear 602 mechanically coupled to the motor 20. The drive gear 602 is magnetically coupled to two magnetic idler gears 604. The magnetic idler gears 604 rotate about a shaft 605 and are coupled to the shaft via one or more mechanical bearings 606 (e.g., ball bearings or roller bearings). The magnetic idler gears 604 are magnetically coupled to pinion gears 607. The pinion gears 607 are secured to a spline 608 which connects to the top spindle 106 of the flywheel 102. Thus, rotational motion of the motor 20 is transmitted via the drive gear 602, idler gear 604, and pinion gears 607 to the flywheel 102. The rotational movement of the drive gear 602 is also transferred to the generator gear 605.

mounted to a shaft of the generator 30. Thus, turning of the drive gear 602 not only causes the flywheel 102 to spin and store mechanical energy, but also to rotate the generator 30 and output electrical energy. In this manner the flywheel assembly 100 can uniquely store and output energy simultaneously, something that chemical batteries such a Li-ion batteries are generally incapable of. As shown in FIG. 2, and detailed further below, each gear of the gear train 600 is composed of two gear segments 612 stacked on each other. Each magnet 609 has an opposite polarity of its neighboring magnets (e.g., N, S, N, S, . . . ) around the circumference of the gear. On neighboring gears, for example the drive gear 602 and the idler gear 604, the magnets are aligned such that at their closest point of approach opposite polarity magnets face each other and seek to attract each other. This attraction of the magnets transfers the rotational movement of the drive gear 602 to the idler gear 604. This is repeated with generator gear 605 and the pinion gear 607. In this way, the gear train 600 has limited friction, and none associated with traditional mechanical gears. The only friction in the gear train are the mechanical gears of the motor, the mechanical gears of the idler gear 604, and the mechanical gears of the generator 30. The result is an incredible increase in efficiency of the gear train 600. The gear train 600 may be housed in an air-tight housing 613, allowing the gear train 600 to be operated in a vacuum and thus further reducing the friction (e.g., windage) of the gear train 600.

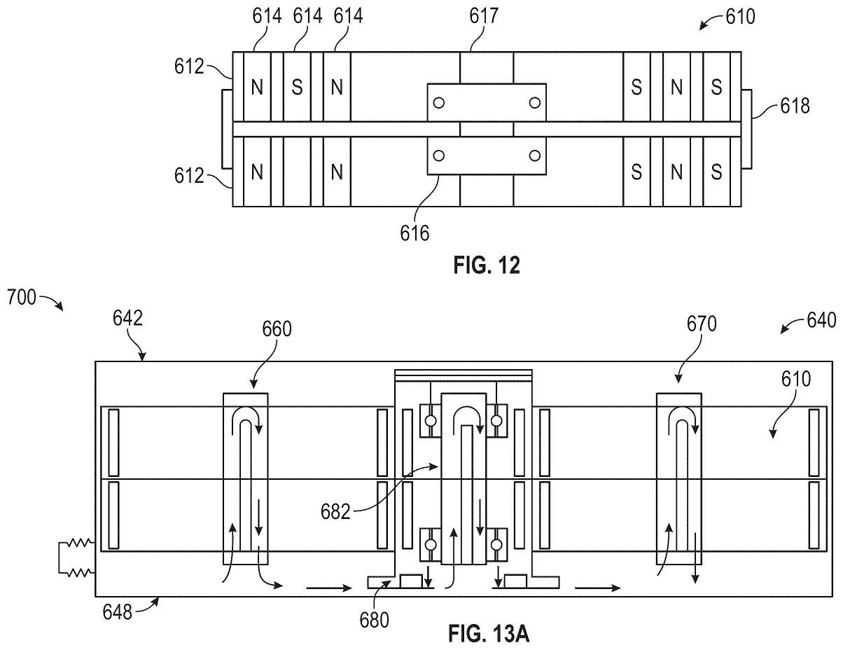

FIG. 12 depicts a magnetic gear 610 in accordance with the disclosure. The magnetic gear 610 may be any of the driven gear 602, idler gear 604, pinion gear 607 or generator gear 605. The primary differences between these are size and the shaft on which they are driven.

The magnetic gear 610 may include a pair of gear segments 612, a plurality of magnets 614 mounted to an exterior surface of each gear segment 612, at least one bearing 616 (e.g., for idler gear 604), a bore 617 for receiving a shaft (e.g., spline 608. The gear segment 612 defines a generally cylindrical profile having an outer surface 612a extending between top and bottom surfaces, respectively.

The gear segment 612 includes a plurality of slots or grooves (not shown) defined therein adjacent the outer surface that is configured to receive magnets 614. The plurality of magnets 614 are arranged such that the magnets alternate polarity from one to the next about the circumference of the gear segment 612. Although generally described as being disposed in corresponding slots or grooves, it is contemplated that the plurality of magnets 614 may be disposed on the outer surface of the gear segment 612 using any suitable means, such as fasteners, adhesives, amongst others. It is envisioned that the plurality of magnets 614 can be secured within the slots or grooves using any suitable means, such as fasteners, adhesives, press fit, amongst others.

With reference to FIG. 12, each of the pair of gear segments 612 is disposed in juxtaposed relation to one another, such that the bottom surface of a first of the pair of gear segments 612 is proximal to or abuts and contacts the bottom surface of a second of the pair of gear segments 612 (e.g., each of the pair of gear segments 612 are mirrored). It is envisioned that the bearing 616 may be disposed within a cavity. Further, it is envisioned that the pair of gear segments 612 may be formed from any suitable material that permits magnetic flux to pass therethrough, such as polymers, non-magnetic metals, ceramics, composites, amongst others. In one non-limiting embodiment, the pair of gear segments 612 is formed from G-10 fiberglass laminate.

Continuing with FIG. 12, the pair of gear segments 612 are coupled to one another via a retaining ring 618 disposed about a circumference of the segment 612. The retaining ring 618 clamps or otherwise secures the pair of gear segments 612 together and inhibits the pair of gear segments 612 from spreading apart from one another. It is envisioned that the retaining ring 618 may be any suitable material capable of securing the pair of gear segments 612 together, such as composite, a non-magnetic metal, a ceramic, a resin, or epoxy, amongst others. In one non-limiting embodiment, the retaining ring 618 is formed from a carbon composite. It is contemplated that the retaining ring 618 may be coupled to the pair of gear segments 612 in any suitable manner, such as fasteners, adhesives, press fit, amongst others. In one non-limiting embodiment, the retaining ring 618 is coupled to the pair of gear segments 612 by a thermal shrink fit.

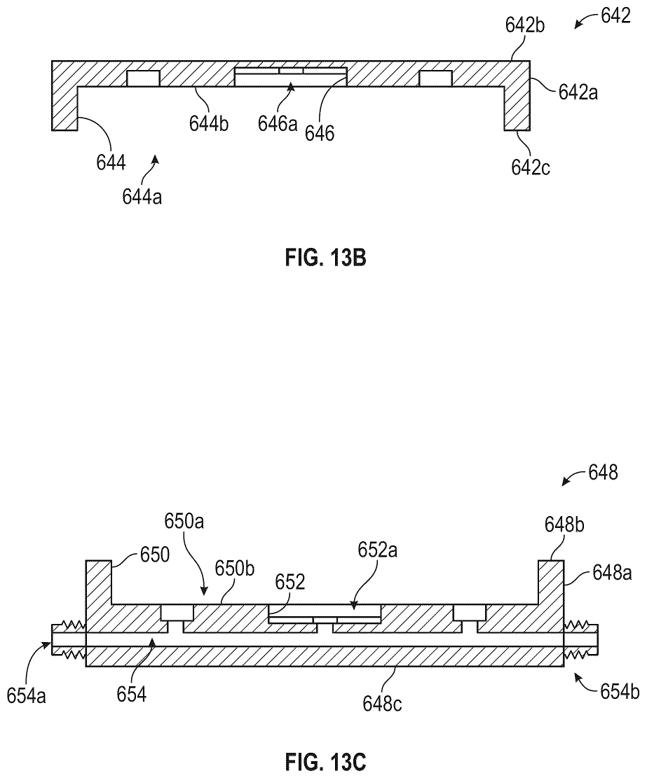

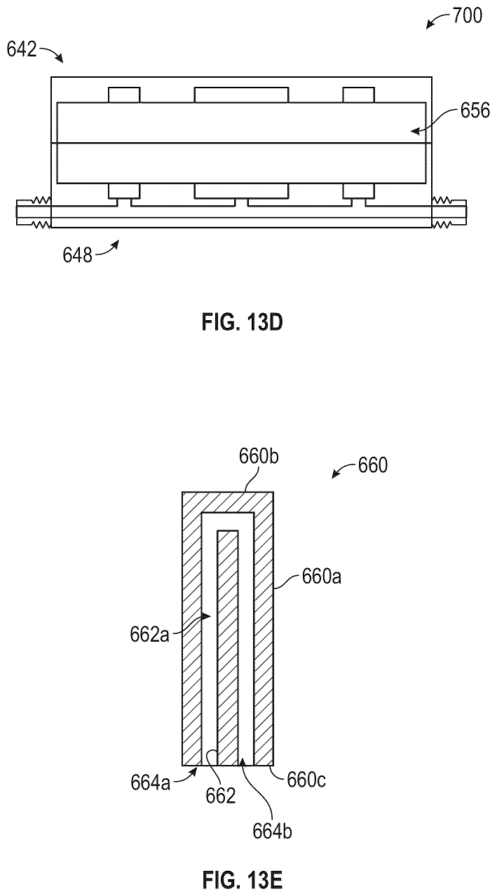

FIGS. 13A-13C depict a liquid-cooled magnetic gear box 700. In one aspect of the disclosure, the gear train 600, may incorporate one or more liquid-cooled gear boxes 700 for cooling of the magnetic gears 610. The liquid-cooled magnetic gear box includes a plurality of magnetic gears 610 and a gearbox housing 640. Each of the plurality of magnetic gears 610 is substantially similar to those described above, and therefore are not redescribed here. As shown in FIG. 13A, the gearbox housing 700 includes first and second cover plates 642 and 648, respectively, first and second gear shafts 660 and 670, respectively, and a center magnetic gear assembly 680.

The first cover plate 642 (FIG. 13B) has an outer surface 642a extending between opposed upper and lower surfaces 642b and 642c, respectively. A first inner surface 644 defines a first counterbore 644a that extends through the lower surface 642c extending towards the upper surface 642b and terminating at a planar surface 644b. A second inner surface 646 defines a second counterbore 646a that extends through the planar surface 644b of the first counterbore 644a extending towards the upper surface 642b. The second counterbore 646a terminates at a second planar surface 646b. The first counterbore 644a is configured to receive the plurality of magnetic gears 610 and the center magnetic gear assembly 680 therein.

The second cover plate 648 (FIG. 13C) defines a substantially similar profile to that of the first cover plate 642. The second cover plate 648 includes an outer surface 648a extending between opposed top and bottom surfaces 648b and 648c, respectively. A first inner surface 650 defines a first counterbore 650a that extends through the top surface 648b extending towards the bottom surface 648c and terminating at a planar surface 650b. A second inner surface 652 defines a second counterbore 652a that extends through the bottom surface 648c of the first counterbore 650a extending towards the bottom surface 648c. The second counterbore 652a is configured to receive a portion of the center magnetic gear assembly 680 such that the center magnetic gear assembly 680 is permitted to rotate therein.

The second cover plate 648 includes one or more cooling channels 654 defined therein in fluid communication with a coolant input 654a disposed on one side of the outer surface 648a and a coolant output 654b disposed on an opposing side of the outer surface 648a. In this manner, a coolant (e.g., a fluid, a gas, etc.) is permitted to flow into the coolant input 654a, through the one or more cooling channels 654, and out of the coolant output 654b. As will be described in further detail hereinbelow, the one or more cooling channels 654 are in fluid communication with portions of the first and second gear shafts 660, 670 and a center gear shaft 682 of the center magnetic gear assembly 680. Although generally described as having one coolant input 654a and one coolant output 654b, it is contemplated that the second cover plate 648 may include any number of coolant inputs 654a and coolant outputs 654b, and the number of coolant inputs 654a may be the same or different than the number of coolant outputs 654b, depending upon the design needs of the liquid-cooled magnetic gear box 600.

Continuing with FIGS. 13C-13D, the first and second cover plates 642, 648 join together to form a complete housing. In this manner, the lower surface 642c of the first cover plate 642 is disposed on the upper surface 648b of the second cover plate 648 such that the first and second cover plates 642, 648 are arranged substantially concentric with one another. The first counterbore 644a of the first cover plate and the first counterbore 650a of the second cover plate cooperate to define a cavity 656. The cavity 656 is configured to rotatably receive the plurality of magnetic gears 610 and the center magnetic gear 680. The first and second gear shafts 660, 670 are disposed within the cavity 656 and anchored therewithin within corresponding bores (not shown) defined in portions of the planar surfaces 644b, 650b of the first and second cover plates 642, 648.

The first and second gear shafts 660, 670 are substantially similar and therefore, only the first gear shaft 660 will be described in detail herein in the interest of brevity. The first gear shaft 660 (FIG. 13D) defines a generally cylindrical profile having an outer surface 660a extending between opposed first and second end surfaces 660b and 660c, respectively. The outer surface 660a of the gear shaft 660 includes an outer dimension that is configured to be received within a portion of a bearing 622 of the magnetic gear 610 such that the magnetic gear 610 is rotatably supported thereon. In this manner, the first gear shaft 660 is fixedly retained within respective potions (e.g., bores, protuberances, etc.) of the first and second cover plates 642, 648. An inner surface 662 defines a channel 662a extending through the first end surface 660b to define an input and an output 664a and 664b, respectively that are in fluid communication with the channel 662a. In this manner, the channel 662a defines a generally “U” shaped profile extending from the input 664a, towards the second end surface 660c, making a generally 180-degree bend such that the channel 662a extends towards the first end surface 660b and through the output 664b. As can be appreciated, the channel 662a enables a coolant (e.g., a fluid, a gas, etc.) to flow therethrough to cool or otherwise reduce the temperature of the first gear shaft 660 and thereby the bearing 622 and/or magnetic gear 610. It is envisioned that the channel 662a may include any suitable shape and may include any suitable number of inputs and/or outputs 664a, 664b. In embodiments, the first gear shaft 660 may include any suitable number of channels 662a, depending upon the design needs of the liquid-cooled magnetic gear box 600. It is contemplated that the first gear shaft 660 may include any suitable profile and may be formed from any suitable material (e.g., a metallic material, a polymer, a ceramic, a composite, etc.) and may be formed using any suitable process, such as machining, additive manufacturing, forming, amongst others. It is envisioned that the first gear shaft 660 may be formed from one unitary piece of material or may be formed from two or more pieces of material joined together using any suitable means, such as welding, fasteners, adhesives, amongst others.

Continuing with FIG. 13A, the center magnetic gear assembly 680 is substantially similar to the magnetic gears 610 and therefore only the differences therebetween will be described in detail herein in the interest of brevity. The center magnetic gear assembly 680 is rotatably secured to the first and second cover plates 642, 648 via the center gear shaft 682, which is substantially similar to the first and second gear shafts 660, 670. In this manner, portions of the center gear shaft 682 are anchored or otherwise secured within respective portions of the first and second cover plates 642, 648, such as bores, counterbores, protuberances, amongst others.

Although generally described as using mechanical bearings 616 to rotatably support the magnetic gears 610 and the center magnetic gear assembly 680, it is envisioned that the mechanical bearings 616 may be replaced by the magnetic bearings 114, 140, 200 as described hereinabove. As can be appreciated, the use of the magnetic bearings reduces mechanical friction caused by the operation of the mechanical bearings 622, and therefore, the cooling system described hereinabove may not be necessary.

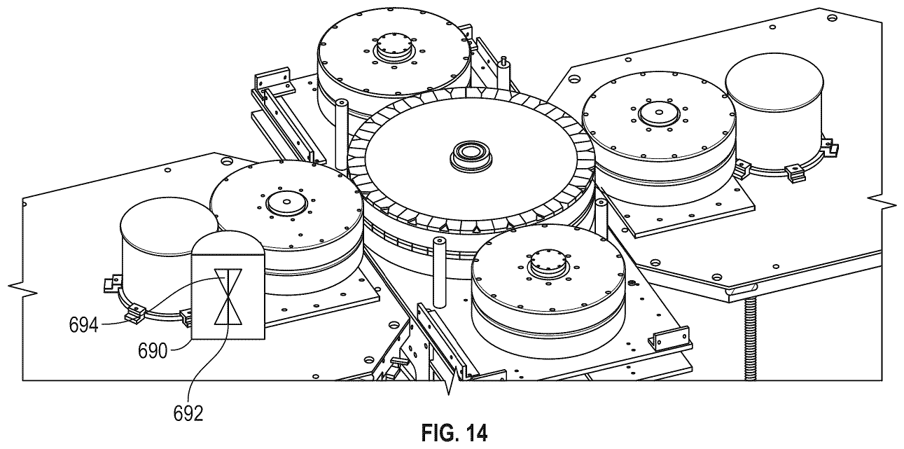

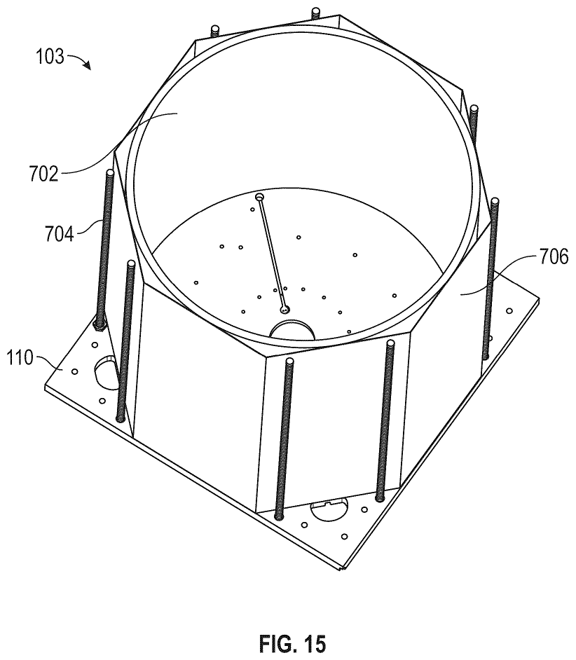

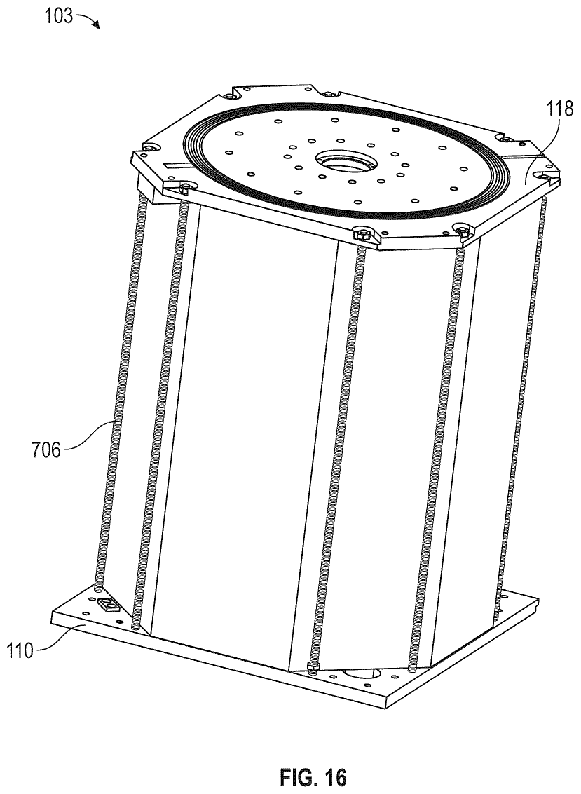

With additional reference to FIG. 14, it is envisioned that the magnetic gear train 600 may include an electromagnetic braking system 690 operably coupled thereto. The electromagnetic braking system 690 includes an electromagnet 692 having a core 694 wrapped with a conducting wire and connected to a source of electrical energy. The electromagnet 692 is mechanically coupled to a portion of the flywheel assembly 100 and in proximity of one or more of the magnetic gears. In FIG. 14 the electromagnet 692 is in proximity to the pinion gear 607 and the idler gear 604. It is envisioned that the core 684 may be formed from any suitable ferromagnetic or ferrimagnetic material, and in embodiments, may be formed from iron. When an electrical current is caused to flow through the electrically conductive wire, a magnetic field is generated which is concentrated by the core 694 and magnetically interacting with the plurality of magnets 609, 614. The continued flow of electricity through the electromagnet 692 causes the plurality of magnetic gears 610 to slow or otherwise cease rotating and arrest rotation of any flywheels 102 magnetically coupled thereto. It is envisioned that the electromagnetic braking system 690 may be powered using any suitable electrical energy source, such as batteries, line voltage, supercapacitors, amongst others.

In addition, in instances of failure it is envisioned that the flywheel assemblies 100 may be slowed or arrested by flooding the flywheel enclosures 103 with a liquid, such as water, a glycol propylene mixture, amongst others. As can be appreciated, the flooding of the flywheel enclosures 103 with a liquid causes an increase in rotational resistance against the flywheels 102 causing the flywheels to slow or be arrested quickly. Although generally described as being water or a glycol propylene mixture, it is envisioned that the liquid may be any suitable liquid that is capable of absorbing heat and/or being compressed without combusting or otherwise releasing harmful energy.

FIG. 15 details some further aspects of the disclosure. FIG. 15 depicts a flywheel enclosure 103 mounted on a base plate 110. The flywheel enclosure 103 may include a pipe section 702 having a diameter of, for example, 12, 18, 24, 30, 36, 48, 54, 60, 55, 72, 78, 84, or 90 inches, and whole integer values or fractions of inches between these values. A plurality of threaded rods 704 extend from the base plate 110 to the top plate 118 (FIG. 16) and secure the pipe section 704 therebetween. The round shape of the pipe section 702 substantially matches the shape of the flywheel 102 and maintains a consistent gap between the pipe section 702 and the flywheel 102. The consistency of the gap between the flywheel 102 and the pipe section 702 reduces friction and windage on the flywheel 102 when spinning at up to 15,000 RPM. Further, the consistent gap substantially eliminates any pressure differentials that might be created if the gap between the flywheel 102 and the pipe section 702 varies in its circumference. In addition, the pipe section 702, is relatively straight forward to manufacture and to work using known machining and manufacturing techniques.

An optional shroud 706 can be employed to cover the pipe section 702 if desired. The shroud 706 can be used for marketing and other purposes without impacting the properties, particularly the thermodynamic properties of the pipe section 702 and the flywheel 102 housed therein. In addition, the air gap between the pipe section 702 and the shroud 706 can provide additional sound insulation, limiting the transmission of sound from the spinning flywheel 102.

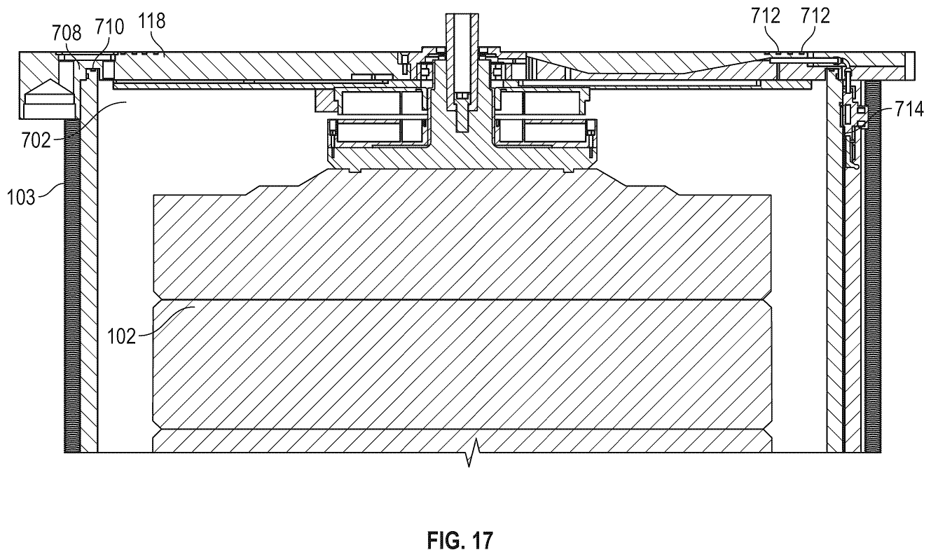

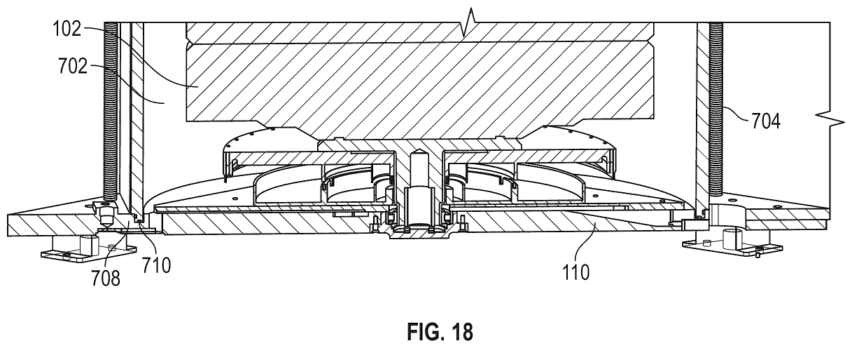

FIG. 17 depicts further aspects of the disclosure. A recess 708, which may be a stepped recess, as shown in FIG. 17 may be machined into the top plate 118. One or more sealing channels 710 can be machined into the pipe section 702, the sealing channels 710 are configured to receive an O-ring (not shown). The interaction of the O-ring and the sealing channels 710 provide an air-tight fit that substantially limits the ingress of air into the flywheel enclosure 103. With reference to FIG. 18, a similar recess 708 can be machined into the base plate 110 and sealing channels 710 machined into the pipe section 702 to receive O-rings. Further, the top plate 118 may have one or more sealing channels 712 machined therein. The sealing channels 712 are also configured to receive O-rings. The sealing channels 712 are configured to mate with the magnetic gear train 600, described above. As with the flywheel, the magnetic gears of the magnetic gear train 600 spin at 6,000 to 20,000 RPM, as such the housing 613 in which the gears of the gear train 600 are located is also under a vacuum, and the sealing channels 712 and O-rings maintain that vacuum, separate from the vacuum of the flywheel enclosure 103.

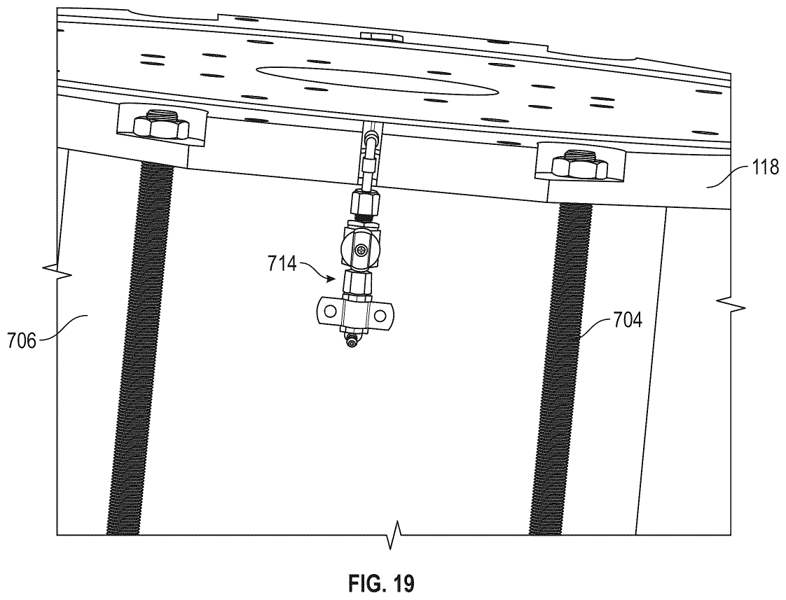

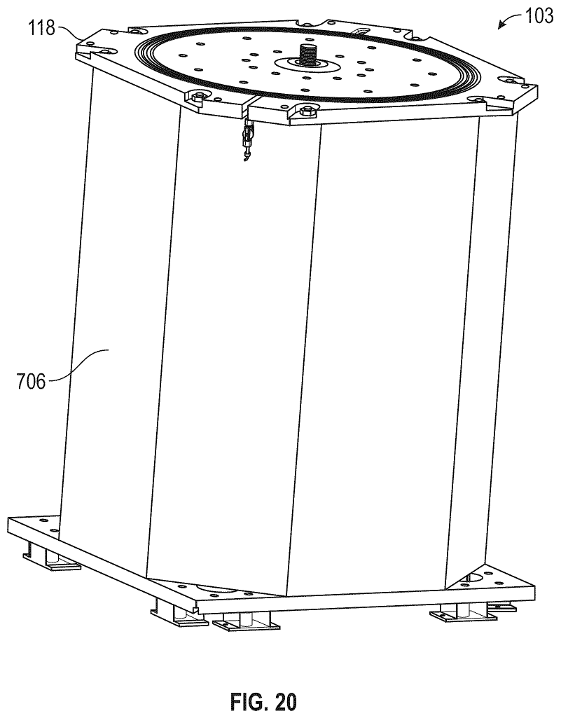

FIG. 19 depicts a vacuum connection 714, the vacuum connection 714 is configured to mate with a vacuum pump (not shown). The vacuum connection 714 is in fluid communication with either the internal volume of the flywheel enclosure 103 or an internal volume of the magnetic gear train housing 613. By connection of a vacuum pump to the vacuum connection 714, a vacuum is achieved within the flywheel enclosure 103 or the magnetic gear train housing 613. As described, elsewhere herein, the combination of vacuum, magnetic lift bearing 114 and magnetic levitating bearing 140 substantially eliminates friction within the flywheel system 10. Further, though shown in other figures as having the threaded rods 704 external to the should 706, the threaded rods 704 may be moved to be within the shroud 706 as depicted in FIG. 20. This may be particularly desirable where aesthetics may be more important.

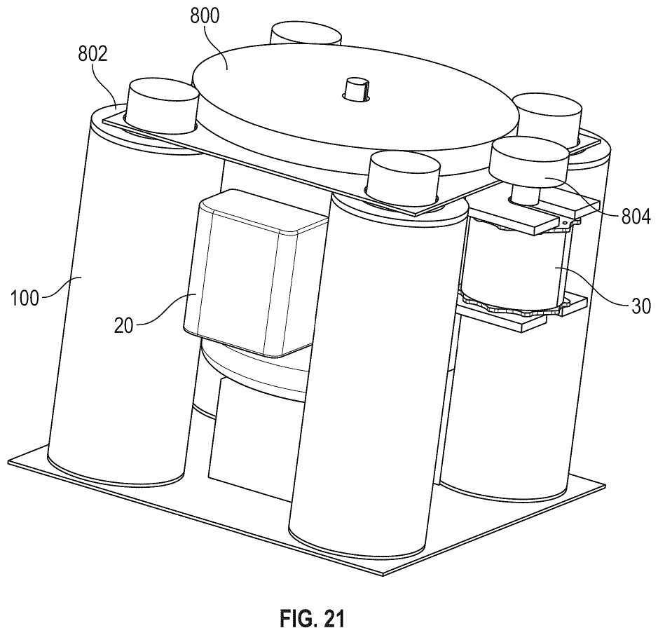

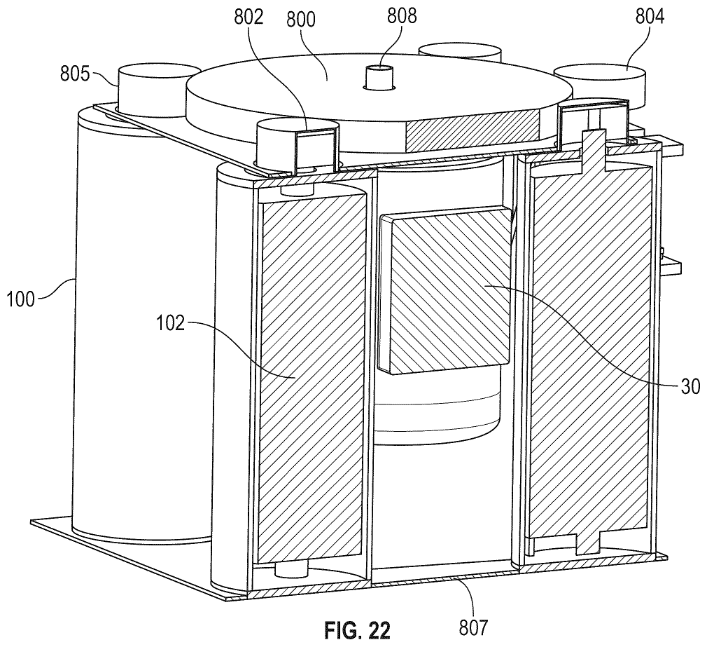

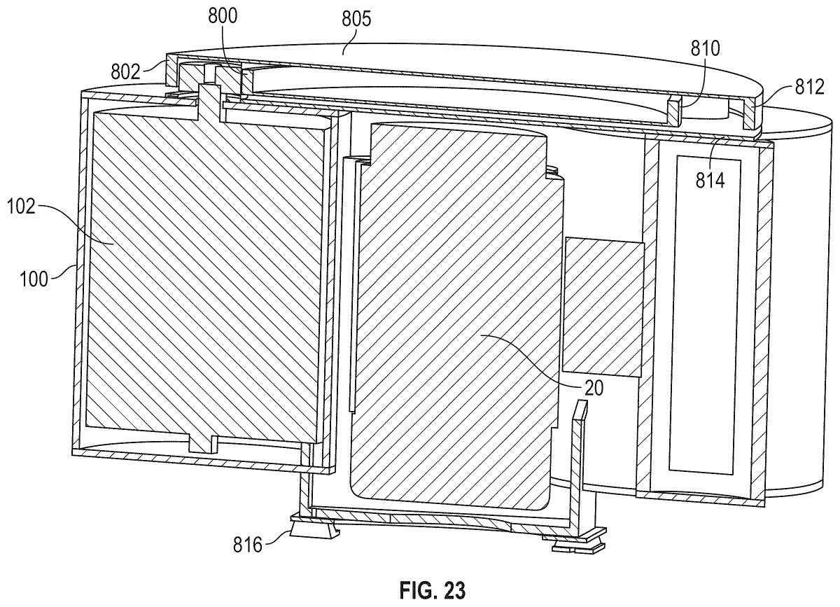

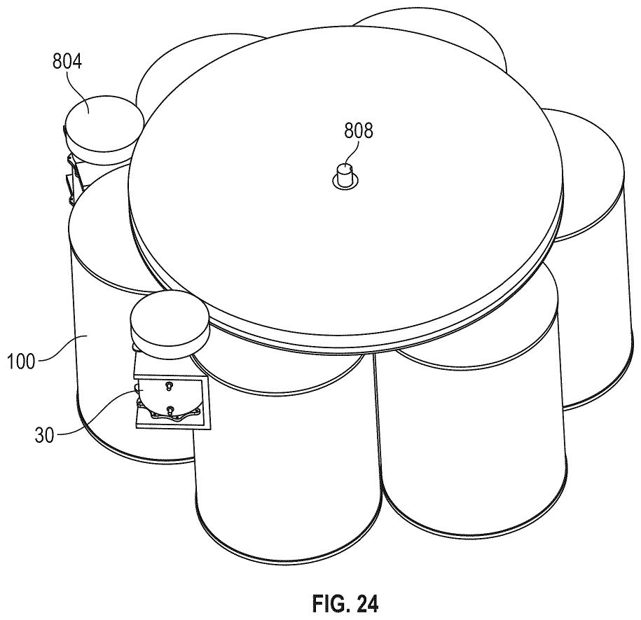

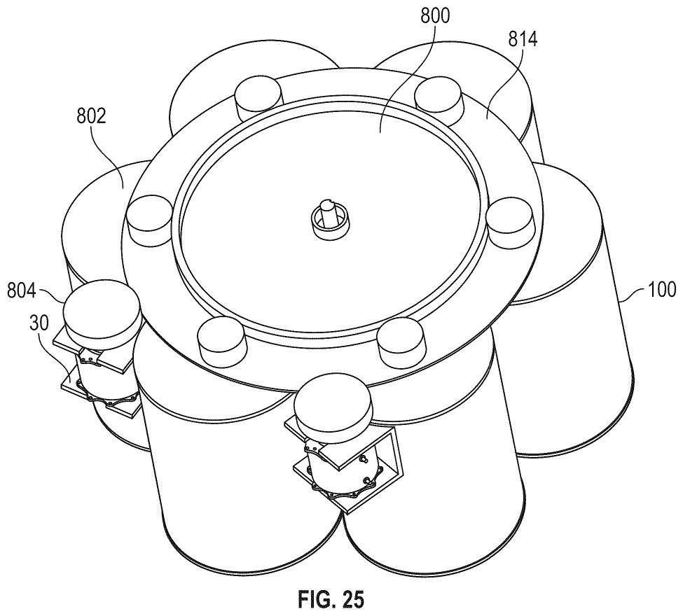

FIGS. 1 and 2 depict an energy storage and generation system 10 with two flywheel assemblies 100, the disclosure is not so limited. FIGS. 21 and 22 depict an energy storage and generation system 10 with four flywheel assemblies 100 arranged around a single motor 20 and including a single generator 30. Similarly, FIGS. 23-25 depict an energy storage and generation system 10 with six flywheel assemblies 100 arranged around a single motor 20 and including two generators 30. Both the aspects depicted in FIG. 21 and FIG. 23 employe a similar magnetic gear train as that described above in connection with FIGS. 1 and 2. In both the aspects of FIGS. 21 and 22 and the aspects of FIGS. 23-25 employe a large central magnetic gear 800 connected to the motor 20 via a shaft 808. The central gear 800 magnetically meshes with pinion gears 802 connected to each flywheel assembly 100. The relative size differential of the central gear 800 compared to the pinion gears 802 ensures that the motor 20 rotating the central gear 800 at for example 1800 RPM, drives the pinion gear 802 at some multiple of RPM. The pinion gears 802, and the therewith the flywheels 102 to which they are connected spin at between 8,000 and 15,000 RPM. Also in magnetic mesh with the magnetic central gear 800 is a generator gear 804. In the embodiment of FIGS. 21 and 22, the generator gear 804 is mates with the central gear 800 on an exterior surface of the central gear 800, essentially the same as the pinion gears 802 connected to the flywheels 102. Each gear 800, 802, 804 is encased in a vacuum housing 805 isolating gear from the atmosphere and reducing the windage and friction experienced by the gear as it rotates. Further, though not depicted in FIGS. 21-22, rather than large central or sun gears 800, as shown, one or more idler gears 604 may be employed to transfer energy without departing from the scope of the disclosure.

Alternatively, the embodiment of FIGS. 23-25 depict a planetary gear train, where the central gear 800 is a sun gear and is coupled to a shaft 808 of the motor 20. An exterior surface 810 of the sun gear or central gear 800 includes a plurality of magnets (as described above) and magnetically meshes with a plurality of magnets on the pinion gears 802 or planetary gears connected to the flywheels 102. Because of the limited access for the generator 30, forcing it to be mounted radially outwards from the flywheel assemblies 100, the generator gear 806 magnetically meshes with a ring gear 812. The ring gear 812 also magnetically meshes with the pinion or planetary gears 802. In this manner energy can be transferred from the motor 20 and the coupled central or sun gear 800 to the pinion or planetary gears 802 connected to the flywheels 102, in addition the planetary or pinion gears 802 magnetically drive the ring gear 812 which is magnetically coupled to and drive the generator gear 804 and generates electrical energy. Those of skill in the art will recognize that the gears employed in the embodiment of FIGS. 21-25 may have a similar construction to the gears of gear train 600.

Further, the magnetic gears 800, 802, 804 and 812 are be housed in one or more vacuum housings 805 chambers (not shown) to substantially eliminate friction and windage of the gears as they rotate. Still further because of their size the central or sun gear 800 and the ring gear 812 may employ magnetic levitation in a similar fashion as described above, by placement of magnets of opposing polarities on the gear and/or a base plate 814 to eliminate the weight and windage of the rotation of the gears. One or more vibration mounts 816 may be employed to support the weight of the flywheels 102, the motor 20. Further, the motor 20 may be optionally connected to the sun gear 800 via a flexible shaft coupling (not shown).

By placing the flywheels 102 in a ring, as shown in FIGS. 23-25, the gear sizes can be varied to improve the overall system gearing ratios. Using the planetary gearing assembly, lower RPM is required on both the sun gear 800 and the ring gear 812 which is much more conducive to common motor and generator rates speeds of 1800 and 3600 RPM. Further, lower RPM motors further reduce the windage and friction experienced by the motor 20 and generator 30, as well as the overall system. Those of skill in the art will recognize that the larger sizes sun gear 800 and ring gear 812 does, however, increase some windage losses. The overall strength of the magnets of the sun gear 800 and the ring gear 812 may be reduced or magnetic shielding may be employed to reduce or eliminate magnetic interference between the two gears. Alternatively, the diameter of the pinion or planetary gear 802 may be increased to reduce the interference.

In yet a further embodiment, the sun gear 800 and the ring gear 812 may be commonly mounted and rotate on a common plate. Thus, the sun gear 800 and the ring gear 812 are both driven by the motor 20, though not technically a planetary gear system, the effects are similar. Further, in some instances either the sun gear 800 or the ring gear 812 may be eliminated, leaving just one of the sun gear 800 or ring gear 812 to interact with both the pinion or planetary gears 802 and the generator gears 804.

Referring to the embodiment of FIGS. 21-22, such an arrangement may be particularly useful in rural and homesteading scenarios. The flywheels 102 may have a diameter of about 10-15 inches in diameter. Though capable of storing less energy (e.g., 5-10 kWh vs 25 kWh per flywheel 102 of FIG. 1) the flywheels 102 of FIGS. 21 and 22 may be manufactured at a lower cost. The motor 20 is sized for the highest peak usage of the home and may be coupled to a gas, diesel, or natural gas electric generator. In some settings a 15-kw natural gas generator needs only to operate 2 or 3 times per day and for a total of approximately 2 hours to charge the flywheels 102 and allow the generators 30 to produce the energy to be used for the home or farm. In addition, photovoltaic solar and/or wind electrical generation can be coupled to the system to drive the motor 20 and potentially eliminate or at least reduce the need for operation of the natural gas generator.

In one aspect of the disclosure, the motor 20 may operate at 1800 or 3600 RPM motor. The flywheels 102 and therewith the pinion gears 804 may rotate at between 10,000 and 15,000 RPM. In one aspect of the disclosure the flywheels 102 for the system depicted in FIGS. 22 and 23 may weigh between 900 and 1500 lbs. each. The relative positions of the flywheels 102 can be accurately placed relative to each other with a base registration plate 807. Though shown in FIGS. 21-25 with four or six flywheels 102, respectively, other numbers of flywheels 102, motors 20, and generators 30 can be arranged around motor 20 as needed for a given installation.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of embodiments. Those skilled in the art will envision other modifications within the scope and spirit of the claims appended hereto.

What is claimed is:

1. An energy storage and production system comprising:
at least one flywheel, the flywheel rotating and storing energy therein ;
at least one motor configured to rotate the flywheel;
a magnetic gear box coupling the at least one motor and the at least one flywheel; and
a generator magnetically coupled to the magnetic gear box and configured to output energy stored in the flywheel.

2. The energy storage and production system of claim 1, wherein the flywheel includes a magnetic lift bearing and a magnetic levitation bearing.

3. The energy storage and production system of claim 2, wherein the magnetic lift bearing is formed of two halves.

4. The energy storage and production system of claim 3, wherein each of the two halves of the magnetic lift bearing includes a plurality of magnets formed into concentric rings.

5. The energy storage and production system of claim 4, wherein each concentric ring of magnets on each of the two halves of the magnetic lift bearing alternates polarity.

6. The energy storage and production system of claim 5, wherein each concentric ring of magnets on a first half of the two halves of the magnetic lift bearing is oriented with a polarity opposite that of a corresponding concentric ring of magnets on a second half of the two halves of the magnetic lift bearing, wherein the opposite polarities cause the first half and the second half of the magnetic lift bearing to attract each other.

7. The energy storage and production system of claim 4, wherein one or more of the concentric rings of magnets is radially supported by a spacer.

8. The energy storage and production system of claim 7, wherein the spacer is formed of a glass reinforced plastic material.

9. The energy storage and production system of claim 8 further comprising one or more shims securing the magnets in the magnetic lift bearing.

10. The energy storage and production system of claim 9, further comprising a cover securing the plurality of magnets in each half of the magnetic lift bearing.

11. The energy storage and production system of claim 1, wherein the flywheel includes a magnetic levitating bearing.

12. The energy storage and production system of claim 11, wherein the magnetic levitating bearing is formed of two halves.

13. The energy storage and production system of claim 12, wherein a bottom half of the magnetic levitating bearing is machined into a bottom plate of a flywheel enclosure.

14. The energy storage and production system of claim 12, wherein each of the two halves of the magnetic levitating bearing includes a plurality of magnets formed into concentric rings.

15. The energy storage and production system of claim 14, wherein each concentric ring of magnets in each of the two halves of the magnetic levitating bearing alternates polarity.

16. The energy storage and production system of claim 15, wherein each concentric ring of magnets on a first half of the two halves of the magnetic levitating bearing is oriented with an identical polarity of a corresponding concentric ring of magnets on a second half of the two halves of the magnetic levitating bearing, wherein the identical polarities cause the first half and the second half of the magnetic levitating bearing to repel each other.

17. The energy storage and production system of claim 16, wherein one or more of the concentric rings of magnets in the magnetic levitating bearing is radially supported by a spacer.

18. The energy storage and production system of claim 17, wherein the spacer is formed of a glass reinforced plastic material.

19. The energy storage and production system of claim 18 further comprising one or more shims securing the magnets in the magnetic levitating bearing.

20. The energy storage and production system of claim 19, further comprising a cover securing the plurality of magnets in each half of the magnetic levitating bearing.
